(19) United States
(12) Patent Application Publication
(10) Pub. No.: US 2026/0044710 A1
(43) Pub. Date: Feb. 12, 2026

(54) ATTENTION NEURAL NETWORKS WITH CONDITIONAL COMPUTATION

(71) Applicant: Google LLC, Mountain View, CA (US)

(72) Inventors: Dmitry Lepikhin, Menlo Park, CA (US); Yanping Huang, Mountain View, CA (US); Orhan Firat, Mountain View, CA (US); Maxim Krikun, Castro Valley, CA (US); Dehao Chen, Fremont, CA (US); Noam M. Shazeer, Palo Alto, CA (US); HyoukJoong Lee, Millbrae, CA (US); Yuanzhong Xu, Mountain View, CA (US); Zhifeng Chen, Sunnyvale, CA (US)

(21) Appl. No.: 19/358,980

(22) Filed: Oct. 15, 2025

Related U.S. Application Data
(63) Continuation of application No. 18/009,841.
(60) Provisional application No. 63/046,545, filed on Jun. 30, 2020.

(51) Int. Cl. G06N 3/042; G06N 3/098

(52) U.S. Cl. CPC G06N 3/042; G06N 3/098

(57) ABSTRACT

Methods, systems, and apparatus, including computer programs encoded on a computer storage medium, for performing a machine learning task on a network input to generate a network output. In one aspect, one of the systems includes an attention neural network configured to perform the machine learning task, the attention neural network including one or more attention layers, each attention layer comprising an attention sub-layer and a feed-forward sub-layer. Some or all of the attention layers have a feed-forward sub-layer that applies conditional computation to the inputs to the sub-layer.

### CROSS-REFERENCE TO RELATED APPLICATION

This application is a continuation of U.S. patent application Ser. No. 18,009,841, which is a National Stage Application under 35 U.S.C. § 371 of International Application No. PCT/US2021/039976, filed on Jun. 30, 2021, which claims priority to U.S. Provisional Application Ser. No. 63/046,545, filed on Jun. 30, 2020, the entirety of which are herein incorporated by reference.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs a machine learning task on a network input using an attention neural network that includes feed-forward sub-layers that employ conditional computation.

Particular embodiments of the subject matter described in this specification can be implemented so as to realize one or more of the following advantages.

The techniques described in this specification allow the computational capacity of a self-attention neural network, e.g., a neural network having a Transformer-based architecture, to be increased without a significant corresponding increase in the amount of computational resources consumed when using the neural network to perform inference. In particular, the described techniques incorporate conditional computation for one or more of the feed-forward sub-layers in the self-attention neural network, resulting in a significant increase in quality of outputs generated for tasks that require processing input sequences, generating output sequences, or both, without a significant increase in the computation cost. Moreover, by parallelizing the resulting self-attention neural network across multiple devices during training as described in this specification, the self-attention neural network can be effectively trained despite having significantly more parameters than existing self-attention networks. Additionally, by selecting which experts are used for any given input at any given position (also referred to as a “token”) during training as described below, the described techniques ensure that the model takes advantage of the increased capacity afforded by the conditional computation and can achieve the significant quality increases described above.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example of a conventional layer and a layer with a conditional computation sub-layer.

FIG. 3 is a flow diagram of an example process for processing a sequence of attended layer inputs using a conditional computation sub-layer.

FIG. 4 shows an example encoder of an attention neural network being deployed across multiple hardware devices.

Like reference numbers and designations in the various drawings indicate like elements.

### DETAILED DESCRIPTION

This specification describes a system implemented as computer programs on one or more computers in one or more locations that performs a machine learning task on a network input to generate network output for the machine learning task.

The machine learning task can be any machine learning task that (i) operates on a network input that is an input sequence, (ii) generates a network output that is an output sequence, or (iii) both.

Some examples of machine learning tasks that the system can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input and the output is a sequence of intensity value inputs for the pixels of an image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

To perform the machine learning task, the system includes an attention neural network that includes multiple attention layers. Each layer operates on a respective input sequence that includes a respective layer input at each of one or more positions.

Moreover, each of the layers includes an attention sub-layer and a feed-forward sub-layer. The attention sub-layer receives the input sequence for the layer and applies an attention mechanism on the input sequence for the layer to generate an attended input sequence. The attention mechanism applied by the attention layer depends on the configuration of the attention neural network, as will be described in more detail below. The feed-forward sub-layer then operates on the attended input sequence to generate an output sequence for the layer.

Generally, the layers within the attention neural network can be arranged in any of a variety of configurations.

As one example, when the network input is an input sequence, the attention neural network can include an encoder neural network that includes a subset of the plurality of layers and that encodes the input sequence to generate a respective encoded representation of each input in the sequence. In this example, the attention mechanism applied by the layers in the encoder is a self-attention mechanism, e.g., a multi-head self-attention mechanism.

As another example, the attention neural network can include a decoder neural network that includes a different subset of the plurality of layers and that processes either the network input or, when the attention neural network also includes the encoder neural network, the encoded representation of the network input to generate the network output. In some of these examples, when the network output is an output sequence, the decoder neural network operates auto-regressively and the attention sub-layers within some or all of the layers of the decoder apply masked self-attention over the partially generated output sequence. When the neural network includes both an encoder and a decoder, some of the layers in the decoder apply cross-attention into the encoded representations while others apply self-attention over the output sequence, either masked or not masked. When the attention neural network includes a decoder neural network that operates directly on the input sequence, the attention layers within the decoder can apply a self-attention mechanism over the input sequence.

The specifics of the operation of the attention layers within the decoder neural network and the encoder neural network are described in more detail in Vaswani, et al, attention Is All You Need, arXiv:1706.03762, and Raffel, et al, Exploring the Limits of Transfer Learning with a Unified Text-to-Text Transformer, arXiv:1910.10683, and Devlin et al, BERT: Pre-training of Deep Bidirectional Transformers for Language Understanding, arXiv:1810.04805, the entire contents of which are hereby incorporated by reference herein in their entirety.

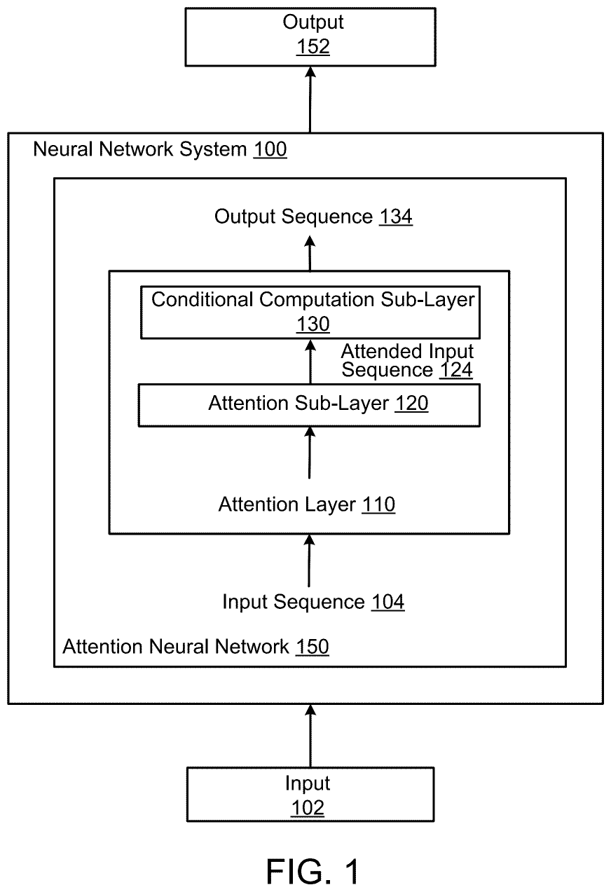

FIG. 1 shows an example neural network system 100. The neural network system 100 is an example of a system implemented as computer programs on one or more computers in one or more locations, in which the systems, components, and techniques described below can be implemented.

The neural network system 100 can receive an input 102 and perform a machine learning task on the input 102 to generate an output 152.

As described above, the neural network system 100 can perform any of a variety of tasks that involve (i) operating on an input 102 that is an input sequence, (ii) generating an output 152 that is an output sequence, or (iii) both.

The neural network system 100 includes an attention neural network 150 that includes multiple attention layers 110.

Each attention layer 110 operates on an input sequence 104 and generates a corresponding output sequence 134.

Although one attention layer is depicted in FIG. 1 for convenience, as described above, the attention neural network 150 generally includes many other layers, including, for example, embedding layers, output layer(s), and other attention layers.

Specifically, the input sequence 104 has a respective input at each of a plurality of input positions in an input order and the output sequence 134 has a respective output at each of the positions in the input order. That is, the attention layer generates a respective output for each input position in the input sequence 104.

In general, the input sequence 104 can be any intermediate sequential data generated by the attention neural network 150 when performing the machine learning task on the input 102. For example, the input sequence 104 can be embedded (i.e., numeric) representations of the system input 102 generated by an embedding layer. As another example, the input sequence 104 can be an output sequence generated by a preceding attention layer or other layer in the attention neural network 150. As another example, when the neural network 150 generates the network output auto-regressively, the input sequence 140 can be embedded representations of the currently generated network output as of the current time step.

To generate the output sequence 134 from the input sequence 104, each attention layer 110 includes an attention sub-layer 120 and a feed-forward sub-layer.

The attention sub-layer 120 receives the input sequence 104 for the layer 110 and applies an attention mechanism on the input sequence for the layer to generate an attended input sequence 124.

Generally, to apply the attention mechanism, the sub-layer 120 uses one or more attention heads. Each attention head generates a set of queries, a set of keys, and a set of values, and then applies any of a variety of variants of query-key-value (QKV) attention using the queries, keys, and values to generate an output. When there are multiple attention heads, the sub-layer 120 then combines the outputs of the multiple attention heads, e.g., by concatenating the outputs and, optionally, processing the concatenated outputs through a linear layer. Examples of QKV attention variants are described in Vaswani, et al, Attention Is All You Need, arXiv:1706.03762, Raffel, et al, Exploring the Limits of Transfer Learning with a Unified Text-to-Text Transformer, arXiv:1910.10683, Devlin et al, BERT: Pre-training of Deep Bidirectional Transformers for Language Understanding, arXiv:1810.04805, Dai, et al, Transformer-XL.: Attentive Language Models Beyond a Fixed-Length Context, arXiv:1901.02860, and Kitaev, et al, Reformer: The Efficient Transformer, arXiv: 2001.04451, the entire contents of which are hereby incorporated by reference herein in their entirety.

Generally, as described above, the layers within the attention neural network can be arranged in any of a variety of configurations and the attention mechanism applied by the attention sub-layer 120 depends on the configuration of the attention neural network 150.

As one example, when the network input is an input sequence, the attention neural network 150 includes an encoder neural network that includes a subset of the plurality of layers and that encodes the input sequence to generate a respective encoded representation of each input in the sequence. In this example, the attention mechanism applied by the attention sub-layers 120 in the encoder is a self-attention mechanism, e.g., a multi-head self-attention mechanism, where the queries, keys, and values are all generated from the input sequence to the attention sub-layer.

As another example, the attention neural network 150 includes a decoder neural network that includes a different subset of the plurality of layers and that processes either the network input or the encoded representation of the network input to generate the network output. In some of these examples, when the network output is an output sequence, the decoder neural network operates auto-regressively and the attention sub-layers 120 within some or all of the layers of the decoder apply masked self-attention over the partially generated output sequence, where the queries, keys, and values are all generated from the input sequence to the attention sub-layer 120.

When the neural network 150 includes both an encoder and a decoder, some of the layers in the decoder apply cross-attention into the encoded representations while others apply self-attention over the output sequence, either masked or not masked. In cross-attention, the queries are generated from the input sequence to the attention sub-layer 120 while the keys and values are generated from the encoded representations of the network input.

When the attention neural network 150 includes a decoder neural network that operates directly on the input sequence, the attention sub-layers 120 within the decoder can apply a self-attention mechanism over the input sequence.

As used in this specification, the term “learned” means that an operation or a value has been adjusted during the training of the attention neural network 150.

In some cases, the attended input sequence 124 is the final output of the attention mechanism. In some other cases, the sub-layer 120 applies one or more other operations, e.g., residual connections, layer normalization, or both, to the final output to generate the sequence 124.

The feed-forward sub-layer then operates on the attended input sequence 124 to generate an output sequence 134 for the layer 110. More specifically, for some or all of the layers 110 in the attention neural network, the feed-forward sub-layer is a conditional computation sub-layer 130 that uses different components to process different attended layer inputs within any given attended input sequence 124.

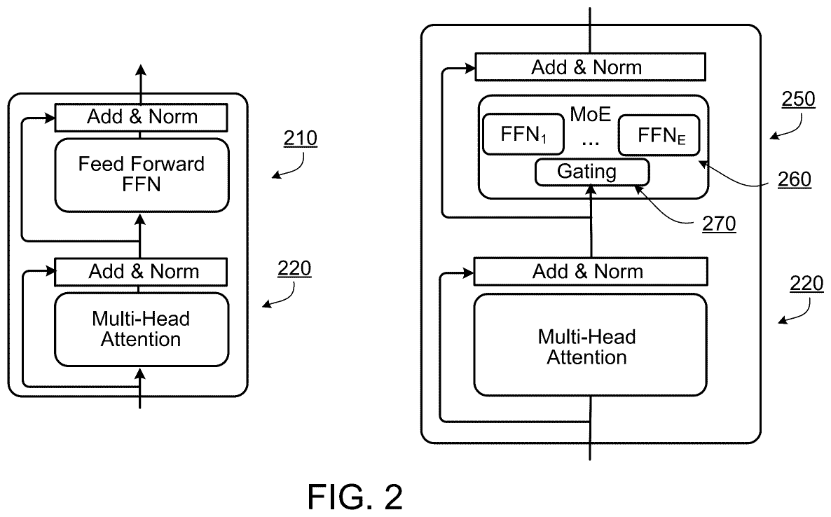

The operations performed by the feed-forward sub-layer are described in more detail below with reference to FIGS. 2-4.

FIG. 2 shows an example of an attention neural network layer that includes a conventional feed-forward sub-layer 210 and an attention neural network layer that includes a conditional computation sub-layer 250.

As described above, both layers include an attention sub-layer 220 that applies an attention mechanism (in the example of FIG. 2, multi-head attention) to an input sequence for the layer and then an “add & norm” operation to generate an attended input sequence. The “add & norm” operation includes a residual connection followed by a layer normalization operation.

Both the feed-forward sub-layer 210 and the conditional computation sub-layer 250 process the attended input sequence to generate an output sequence for the attention neural network layer 250 that includes a respective output for each attended layer input in the attended input sequence. Attended layer inputs that are provided as input to a given sub-layer will also be referred to in this specification as “tokens.”

The feed-forward sub-layer 210 is configured to operate on each position in the attended input sequence separately, i.e., in a position-wise manner. In particular, for each input position, the feed-forward sub-layer 130 is configured receive an attended layer input at the input position and apply a set of transformations to the attended layer input at the input position to generate an output for the input position. The transformations applied by the sub-layer 130 will generally be the same for each input position (but different feed-forward sub-layers in the attention neural network will apply different transformations).

More specifically, the feed-forward sub-layer 210 includes a feed forward neural network (FFN) that operates on each position in the attended input sequence separately, i.e., in a position-wise manner. The FFN can be, e.g., a multi-layer, e.g., two layer or three layer, neural network of fully-connected layers with, e.g., a ReLU or GeLU activation function.

In particular, for each input position, the feed-forward sub-layer 210 is configured receive an attended layer input at the input position and to process the attended layer input using the FFN to generate an initial output for the input position.

Thus, the feed-forward sub-layer 210 processes each attended layer input using the same FFN.

The feed-forward sub-layer 210 then applies an “add&norm” operation to the initial outputs to generate the output sequence for the attention layer.

The conditional computation sub-layer 250 also operates in a position-wise matter, but, instead of processing each attended layer input using the same FFN, maintains a plurality of expert FFNs 260 (also referred to as “experts”).

Each expert generally has the same architecture, but has different parameter values as a result of the training of the attention neural network. For example, each expert can be a multi-layer, e.g., two layer or three layer, neural network of fully-connected layers with, e.g., a ReLU or GeLU activation function.

For any given input position, the conditional computation sub-layer 250 applies a gating function 270 to the respective token at the position to generate a respective gate score for each of the plurality of experts 260.

Generally, the gating function 260 is a function that has learned parameters and that maps a token to the respective gate scores in accordance with the learned parameters. As a particular example, the gating function 270 can generate a respective initial score for each expert by computing a dot product between a learned vector for the expert and the attended layer input for the position and then compute the gate scores by applying a softmax function to the initial scores.

For each token, the conditional computation sub-layer 250 then selects, from the plurality of expert FFNs, a proper subset based at least on the respective gate scores. Thus, the sub-layer 250 performs conditional computation, i.e., performs different operations for different tokens.

Generally, the conditional computation sub-layer 250 selects at most k of the E experts to be in the proper subset, with k being a positive integer that is small relative to the total number of experts E. As a particular example, k can be equal to 2 or another small integer less than ten, while E is equal to at least 100. In some cases E can be equal to at least 500. In some of these cases, E is equal to at least 2000. Thus, for a given attended layer input, the sub-layer selects, for example, at most 2 percent and, in some cases, at most 0.1% of the experts. In other words, while maintaining a large number of experts E affords the attention neural network with significant additional capacity (and increases the total number of parameters of the neural network), only a small fraction are used for any given input, allowing for the processing of an input using the neural network to remain computationally efficient.

In particular, after training of the attention neural network, the sub-layer 250 can select the top k experts, i.e., the k experts with the highest gate scores, as the experts in the proper subset.

During training of the attention neural network, however, the sub-layer 250 can select the k experts using one or more additional criteria to ensure that the load is balanced across the experts (and across the devices on which the experts are implemented) and so that the training process is efficient at scale, i.e., when Eis on the order of thousands and there are millions of attended layer inputs (“tokens”) that need to be processed in a given training batch.

In particular, during training, a training system, e.g., the system 100 of FIG. 1 or a different system implemented as computer programs on one or more computers in one or more location, repeatedly trains the neural network is on batches of training examples that each include a network input and a target output for the network input. In particular, the system can perform a conventional machine learning training technique to train the attention layers, the output layer(s), and any other learned components of the neural network, e.g., a gradient descent with backpropagation training technique that uses a conventional optimizer, e.g., stochastic gradient descent, RMSprop, or Adam optimizer, to minimize a loss function that is appropriate for the task that the attention neural network is configured to perform. During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the attention neural network in parallel. Moreover, the system can first pre-train the neural network on a large unsupervised data set through unsupervised learning, e.g., to minimize a BERT loss or other unsupervised loss, and then fine-tune the neural network on task-specific training data to optimize the loss function for the task.

To process all of the network inputs in a given training batch, the conditional computation sub-layer 250 needs to process N total tokens, i.e., N is the total number of tokens that are included in all of the attended input sequences generated by the attention sub-layer across all of the network inputs in the given training batch. Because of the size of the network inputs, network outputs, or both that are processed by or generated by the attention neural network, N can be in the millions.

During the training of the neural network on a given training batch, the sub-layer can divide the N total tokens “in” the given batch into G groups, so that each group contains S=N/G tokens. The sub-layer then assigns each group a maximum number (“capacity”) and selects the experts for each token in the group so that at most the maximum number of tokens are dispatched to any given expert among all of the tokens in the group while still selecting at most k experts for each token. For example, when k is equal to 2, each group can be assigned a capacity equal to 2N/(GE). More generally, the capacity can be equal to O(N/GE). This ensures that among all of the N tokens for the batch, no expert is assigned more than O(N/GE) of the tokens for the training batch.

Moreover, the system can perform the processing for the tokens in each group independently and in parallel. Within each group, the system can perform the selection of experts sequentially in order to ensure that the constraints are satisfied within each group.

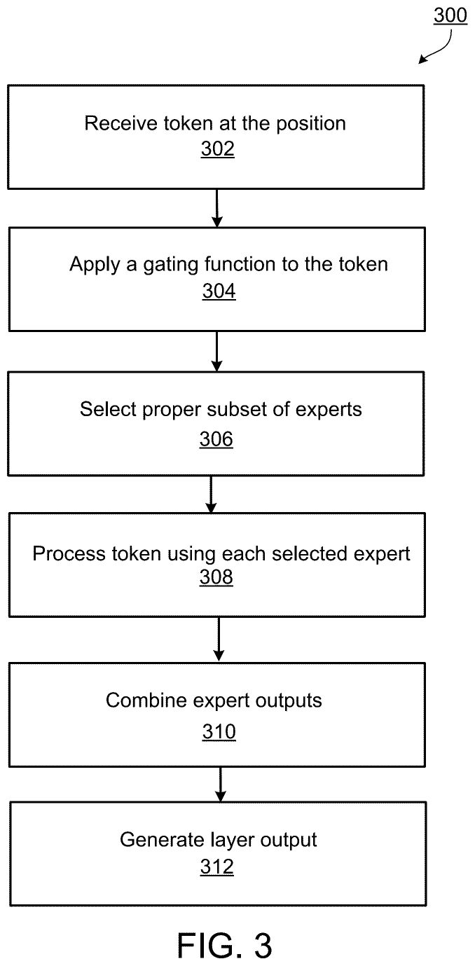

Selecting experts during training to ensure that no expert is assigned more than O(N/GE) of the tokens for the training batch is described in more detail below with reference to FIG. 3.

The sub-layer 250 then processes the respective attended layer input at the given position using each of the expert FFNs in the proper subset, i.e., and not using any of the expert FFNs that are not in the proper subset, to generate a respective expert output for each of the expert FFNs in the proper subset.

The sub-layer 250 then combines the respective expert outputs to generate a combined expert output. In particular, the sub-layer can generate a respective normalized gate score for each selected expert feed-forward neural network and compute a weighted sum of the respective expert outputs, with each expert output weighted by the normalized gate score for the selected expert feed-forward neural network that generated the expert output. The sub-layer can compute the respective normalized gate score for each selected expert by normalizing the gate scores for the k experts with the highest gate scores so that the gate scores for the k experts sum to one.

The sub-layer 250 generates the respective layer output at the position from the combined expert output. For example, the feed-forward layer can use the combined expert outputs at the positions as the respective layer outputs or, as shown in FIG. 2, can apply an “add & norm” operation to the combined expert outputs for the input positions to generate the respective layer outputs.

In some implementations, each of the attention layers within the attention neural network layer have a feed-forward sub-layer that is a conditional computation sub-layer 250.

In some other implementations, only a proper subset of the attention layers in the attention neural network layers have feed-forward sub-layers that are conditional computation sub-layers 250. For each layer that is not in the proper subset, the feed-forward sub-layer processes is a conventional feed-forward sub-layer 210, i.e., that processes each respective attended layer input at each of the positions in the layer input to the layer using a single FFN.

As a particular example, the attention layers in the attention neural network can be arranged in a sequence and every second layer in the sequence can have a feed-forward sub-layer that is a conditional computation sub-layer 250. That is, the sequence alternates between attention layers with conventional feed-forward sub-layers 210 and attention layers with conditional computation sub-layers 250. When the attention neural network includes both an encoder and a decoder, both the encoder and the decoder can have the same arrangement, e.g., with every other attention layer or some other proper subset of attention layers having conditional computation sub-layers 250.

FIG. 3 is a flow diagram of an example process 300 for generating a layer output from an attended input sequence. For convenience, the process 300 will be described as being performed by a system of one or more computers located in one or more locations. For example, a neural network system, e.g., neural network system 100 of FIG. 1, appropriately programmed in accordance with this specification, can perform the process 300.

In general, the system receives, at a feed-forward sub-layer included in an attention layer, an attended input sequence that includes a respective attended layer input at each of a plurality of positions and generates, from the attended input sequence, an output sequence for the attention layer that includes a respective layer output at each of the one or more positions.

The attended input sequence was generated by an attention sub-layer within the attention layer that is configured to receive an input sequence for the attention layer that includes a respective layer input at each of the one or more positions and generate the attended input sequence at least in part by applying an attention mechanism to the input sequence for the layer.

As described above, the system implements the operations of the feed-forward sub-layer by performing conditional computation. In particular, the system can perform steps 302-312 for each attended layer input (“token”) at each position in the attended input sequence.

The system receives the token at the position (step 302).

The system applies a gating function to the respective attended layer input at the position to generate a respective gate score for each of the plurality of expert feed-forward neural networks (“experts”) (step 304). As described above, the gating function is a function that has learned parameters and that maps a token to the respective gate scores in accordance with the learned parameters.

The system selects, from the plurality of experts, a proper subset of the experts based at least on the respective gate scores for the experts (step 306). Generally, the system selects at most k of the E experts to be in the proper subset, with k being a positive integer that is small relative to the total number of experts E.

After training of the attention neural network, the system can select the top k experts, i.e., the k experts with the highest gate scores, as the experts in the proper subset.

As described above, during training of the attention neural network, the system can select the k experts using one or more additional criteria to ensure that the load is balanced across the experts (and across the devices on which the experts are implemented) and so that the training process is efficient at scale, i.e., when E is on the order of thousands and there are millions of attended layer inputs (“tokens”) that need to be processed in a given training batch.

During the training of the neural network on a given training batch, the system can divide the N total tokens “in” the given batch into G groups, so that each group contains S=N/G tokens. The system then assigns each group a maximum number (“capacity”) and selects the experts for each token in the group so that at most the maximum number of tokens are dispatched to any given expert among all of the tokens in the group while still selecting at most k experts for each token. For example, when k is equal to 2, each group can be assigned a capacity equal to 2N/(GE). More generally, the capacity can be equal to O(N/GE). This ensures that among all of the N tokens for the batch, no expert is assigned more than O(N/GE) of the tokens for the training batch.

Moreover, the system can perform the processing for the tokens in each group independently and in parallel. Within each group, the system can perform the selection of experts sequentially in order to ensure that the constraints are satisfied within each group. Thus, dividing the tokens into groups ensures that the sequential processing does not bottleneck the training of the attention neural network, i.e., as opposed to sequentially assigning each of N tokens in the batch.

To effectively select the experts for each token in the group so that at most the maximum number of tokens are dispatched to any given expert among all of the tokens in the group while still selecting at most k experts for each token, for a given token within a given group, the system can first identify the k experts with the highest gate scores for the given token.

The system can determine, for each of the k identified experts, whether the identified expert has already been selected the maximum number of times during the processing of the group.

The system then selects an identified expert only when the expert has not already been selected a maximum number of times during the processing of the group.

Thus, when each of the k identified experts have already been selected a maximum number of times during the processing of the group, the system selects a subset that includes zero expert feed-forward neural networks and sets the combined output for the given token to zero. Because of the residual connection that is applied after the combined output is generated, the system effectively “skips” the computation of the expert feed-forward neural networks by setting the combined output to zero.

In some implementations, when at least one of the k identified experts has not yet been selected the maximum number of times during the processing of the group, the system selects each of the k identified experts that have not yet been selected the maximum number of times as the proper subset for the token.

In some other implementations, the system applies one or more additional criteria for the selection of the subset. That is, even if a given identified expert has not yet been selected the maximum number of times, the system applies one or more additional criteria in order to determine whether to include the given identified expert in the proper subset for the token.

As a particular example, the system can, with some probability, determine not to include one or more lowest scoring experts of the k experts in order to conserve the capacity of the experts. Because, as described above, the outputs of the selected experts are weighted by a weight that is defined by the gate score for the corresponding expert when computing the combined expert output, not including the one or more lowest scoring experts can conserve capacity without excessively impacting the computation performed by the attention neural network.

In more detail, for one or more of the k identified experts, i.e., the one more experts with the lowest gate scores, the system can determine a probability for the expert from at least the gate score for the expert feed-forward neural network and select the expert feed-forward neural network only when (i) the expert feed-forward neural network has not already been selected the maximum number of times during the processing of the group and (ii) the probability for the expert feed-forward neural network exceeds a randomly sampled value between zero and one, e.g., sampled from a uniform distribution of values between zero and one. The system can determine the probability for the expert, e.g., by normalizing the gate scores for the k identified experts so that the gate scores sum to one and using the normalized the score for the expert as the probability.

The system processes the token at the position using each of the experts in the proper subset to generate a respective expert output for each of the experts in the subset (step 308). Thus, the system does not process the token using any of the experts that are not in the proper subset.

The system combines the respective expert outputs to generate a combined expert output (step 310).

In particular, the sub-layer can generate a respective normalized gate score for each selected expert feed-forward neural network and compute a weighted sum of the respective expert outputs, with each expert output weighted by the normalized gate score for the selected expert feed-forward neural network that generated the expert output. The sub-layer can compute the respective normalized gate score for each selected expert by normalizing the gate scores for the k experts with the highest gate scores so that the gate scores for the k experts sum to one.

As above, when no tokens are selected for the token, the system sets the combined expert output to zero, i.e., to a vector of all zeroes.

The system generates the respective layer output at the position from the combined expert output (step 312). For example, the feed-forward layer can use the combined expert outputs at the positions as the respective layer outputs or, can apply a residual connection, a normalization operation, e.g., layer normalization, or both, to the combined expert outputs for the input positions to generate the respective layer outputs.

For each attention layer in the attention neural network, the system can repeatedly (i.e., at each of one or more attention sub-layers included in the attention layer) perform the process 300 to update the input sequence to the layer or, if the attention layer has a conventional feed-forward sub-layer, perform the operations of the conventional feed-forward sub-layer to update the input sequence to the alyer. By repeatedly performing the process 300 for all of the attention layers in the attention neural network and then by processing at least part of the output sequence generated by the last attention layer in the attention neural network using one or more output layers, the system can generate a network output for a received network input.

That is, the process 300 can be performed as part of predicting an output for an input for which the desired output, i.e., the output that should be generated by the system for the input sequence, is not known.

As described above, the process 300 can also be performed as part of processing inputs derived from a set of training data, i.e., inputs derived from a set of inputs for which the output that should be generated by the system is known, in order to train the attention neural network to determine trained values for the parameters of the attention neural network. The system can repeatedly perform the process 300 on inputs selected from a set of training data as part of a conventional machine learning training technique to train the attention layers and the output layer(s) of the neural ntework, e.g., a gradient descent with backpropagation training technique that uses a conventional optimizer, e.g., stochastic gradient descent, RMSprop, or Adam optimizer, to optimize an objective function that is appropriate for the task that the attention neural network is configured to perform. During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the attention neural network in parallel. Moreover, the system can first pre-train the neural network on a large unsupervised data set through unsupervised learning, e.g., to minimize a BERT loss or other unsupervised loss, and then fine-tune the neural network on task-specific training data to optimize the objective function for the task.

In some implementations, in addition to or instead of the above modifications that directly impact how the selection happens during training, the system also trains the self-attention neural network on a loss function that includes a term that encourages the conditional computation feed-forward sub-layer to select each expert feed-forward neural network for the same fraction of attended layer inputs among a total number of attended layer inputs within the group.

In other words, the loss function includes, for each conditional computation feed-forward sub-layer in the attention neural network, a corresponding loss term that is minimized when each expert is selected for the same number of tokens during the processing of a given group of tokens.

More specifically, the fraction of tokens routed to any given expert is derived from a non-differentiable operation, i.e., the hard selection of at most k of the experts for teach token, and therefore cannot be directly measured by the loss term. Instead, the loss term is a differential approximation of the mean of the square of the fractions tokens routed to the set of experts for a given group. More specifically, the loss term is equal to the mean of, for each expert, the product of (i) the fraction of tokens in the group for which the expert was selected and (ii) the mean of the gate scores assigned to the expert among the tokens in the group. Because the mean gate score is a differentiable computation, the gradient of this term can be directly computed with respect to the parameters of the gating function and can therefore be used during training of the neural network.

Moreover, as described above, in some implementations, during training, during inference after training, or both, the system implements the attention neural network by parallelizing the neural network across multiple hardware devices. For example, the system can implement the attention neural network across multiple hardware accelerators, e.g., Tensor Processing Units (TPUs), graphics processing units (GPUs), or both.

In these cases, the system can distribute the conditional computation sub-layers different from the other components of the attention layers in the attention neural network.

In particular, because of the large number of expert neural networks that are included in each conditional computation sub-layer, the system can shard each conditional computational sub-layer across two or more of the plurality of devices while replicating each attention sub-layer across two or more of the plurality of devices.

Replicating a layer across two or more devices means that each of the two or more devices has a copy of the layer.

Sharding a layer across two or more devices means that the components of the layer are divided among the two or more devices, so that each device performs only a portion of the computation required by the layer.

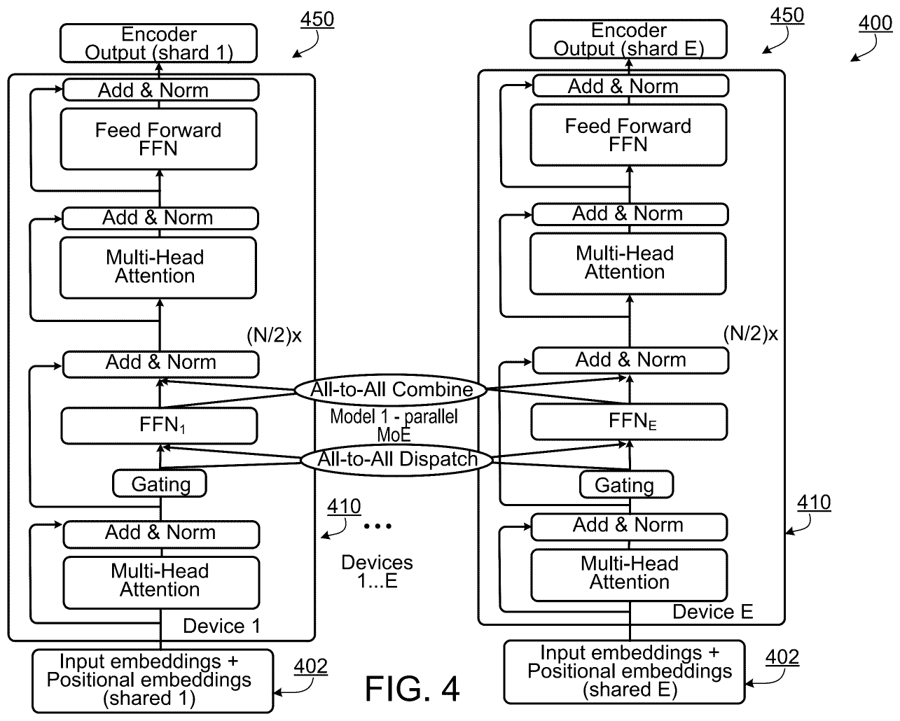

FIG. 4 shows an example encoder 400 of an attention neural network being deployed across multiple hardware devices.

In particular, in the example of FIG. 4, the encoder 400 includes N/2 pairs 410 of attention layers. Each pair of attention layers includes an attention layer with a conditional sub-layer followed by an attention layer with a conventional feed-forward sub-layer.

Thus, the encoder 400 receives a set of embeddings 402 that represent a network input and that are generated from input embeddings for the individual inputs in the network input and positional embeddings that encode the position of each individual input in the network input. The encoder 400 processes the set of embeddings 402 through each of the pairs 410 of attention layers to generate an encoder output 450.

More specifically, the encoder 400 is distributed across E devices. Each of the E devices receives input embeddings 402 for a respective shard, e.g., a respective partition, of the network inputs in a batch of multiple network inputs and processes the input embeddings 402 to generate the encoder outputs 450 for each of the network inputs in the respective shard.

For each of the pairs 410 of attention layers, each of the E devices runs (i) a copy of the respective attention sub-layers in both of the attention layers, (ii) a copy of the conventional feed-forward sub-layer in the second attention layer in the pair, and (iii) a copy of the gating function for the conditional computation sub-layer. However, each of the E devices runs only a respective one of the E experts for the conditional computation sub-layer. Thus, the experts are sharded across the E devices.

In order to compute the output of the conditional computation sub-layer for a given token, the device to which the token is assigned selects at most k of the experts as described above and then dispatches the token to the device(s) on which the k experts are deployed (“all-to-all dispatch”). The expert outputs of the k experts are then dispatched back to the device, which combines them to generate the output of conditional computation sub-layer as described above (“all-to-all combine”).

Thus, because the experts are sharded across the multiple devices, cross device communication is required to compute the encoder outputs 450. However, because only a sparse proper subset of experts is selected for any given token as described above and because of the mechanisms for ensuring that each expert (and each device) receives a balanced load for each batch of tokens, the cross device communication does not bottleneck the training or inference. More specifically, the mechanisms described for balancing the load avoid most tokens being dispatched to a small number of experts, amassing a very large input buffer for only a few (busy) experts and leaving other experts untrained, slowing down the training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that, when executed by the one or more computers, cause the one or more computers to implement:
an attention neural network configured to process a network input to generate a network output for a machine learning task, the attention neural network comprising a plurality of layers, each layer comprising an attention sub-layer and a feed-forward sub-layer, the attention sub-layer configured to:
receive an input sequence for the layer comprising a respective layer input at each of one or more positions; and
generate an attended input sequence at least in part by applying an attention mechanism to the input sequence for the layer, the attended input sequence comprising a respective attended layer input at each of the one or more positions, and
the feed-forward layer configured to:
receive the attended input sequence; and
generate an output sequence for the layer from the attended input sequence, the output sequence comprising a respective layer output at each of the one or more positions,
wherein, for a first subset of the plurality of layers, the feed-forward sub-layer is a conditional computation sub-layer that (i) comprises a plurality of expert feed-forward neural networks and (ii) is configured to generate the output sequence for the layer by performing operations comprising, for each of the positions in the input sequence for the layer:
receiving the respective attended layer input at the position;
applying a gating function to the respective attended layer input at the position to generate a respective gate score for each of the plurality of expert feed-forward neural networks;
selecting, from the plurality of expert feed-forward neural networks, one or more expert feed-forward neural networks based at least on the respective gate scores;
processing the respective attended layer input at the position using each expert feed-forward neural in a proper subset of the plurality of expert feed-forward neural networks to generate a respective expert output for the expert feed-forward neural network in the proper subset, wherein the proper subset of the plurality of expert feed-forward neural networks comprises the one or more expert feed-forward neural networks that have been selected based at least on the respective gate scores;
combining the respective expert outputs to generate a combined expert output; and
generating the respective layer output at the position from the combined expert output.

2. The system of claim 1, wherein selecting the one or more expert feed-forward neural networks based at least on the respective gate scores comprises:
selecting k expert feed-forward neural networks with k highest respective gate scores among the plurality of expert feed-forward neural networks.

3. The system of claim 2, wherein k=1.

4. The system of claim 2, wherein k=2.

5. The system of claim 1, wherein, for a second subset of the plurality of layers, the feed-forward sub-layer is not a conditional computation sub-layer and is configured to generate the output sequence for the layer by processing the respective attended layer input at each of the one or more positions in the attended input sequence using a same feed forward neural network.

6. The system of claim 1, wherein the plurality of expert feed-forward neural networks have a same architecture but different parameter values.

7. The system of claim 1, wherein the attention mechanism comprises a multi-head self-attention mechanism.

8. The system of claim 1, wherein the machine learning task comprises one of:
a text generation task where the network output comprises a sequence of text; or
an image generation task where the network output comprises a sequence of intensity values for pixels of an image.

9. One or more non-transitory computer-readable storage media storing instructions that when executed by one or more computers cause the one or more computers to implement:
an attention neural network configured to process a network input to generate a network output for a machine learning task, the attention neural network comprising a plurality of layers, each layer comprising an attention sub-layer and a feed-forward sub-layer, the attention sub-layer configured to:
receive an input sequence for the layer comprising a respective layer input at each of one or more positions; and
generate an attended input sequence at least in part by applying an attention mechanism to the input sequence for the layer, the attended input sequence comprising a respective attended layer input at each of the one or more positions, and
the feed-forward layer configured to:
receive the attended input sequence; and
generate an output sequence for the layer from the attended input sequence, the output sequence comprising a respective layer output at each of the one or more positions,
wherein, for a first subset of the plurality of layers, the feed-forward sub-layer is a conditional computation sub-layer that (i) comprises a plurality of expert feed-forward neural networks and (ii) is configured to generate the output sequence for the layer by performing operations comprising, for each of the positions in the input sequence for the layer:
receiving the respective attended layer input at the position;
applying a gating function to the respective attended layer input at the position to generate a respective gate score for each of the plurality of expert feed-forward neural networks;
selecting, from the plurality of expert feed-forward neural networks, one or more expert feed-forward neural networks based at least on the respective gate scores;
processing the respective attended layer input at the position using each expert feed-forward neural in a proper subset of the plurality of expert feed-forward neural networks to generate a respective expert output for the expert feed-forward neural network in the proper subset, wherein the proper subset of the plurality of expert feed-forward neural networks comprises the one or more expert feed-forward neural networks that have been selected based at least on the respective gate scores;
combining the respective expert outputs to generate a combined expert output; and
generating the respective layer output at the position from the combined expert output.

10. The computer-readable storage media of claim 9, wherein selecting the one or more expert feed-forward neural networks based at least on the respective gate scores comprises:
selecting k expert feed-forward neural networks with k highest respective gate scores among the plurality of expert feed-forward neural networks.

11. The computer-readable storage media of claim 10, wherein k=1.

12. The computer-readable storage media of claim 10, wherein k=2.

13. A method performed by one or more computers, the method comprising:
receiving a network input; and
processing the network input using an attention neural network to generate a network output for a machine learning task, the attention neural network comprising a plurality of layers, each layer comprising an attention sub-layer and a feed-forward sub-layer, the attention sub-layer configured to:
receive an input sequence for the layer comprising a respective layer input at each of one or more positions; and
generate an attended input sequence at least in part by applying an attention mechanism to the input sequence for the layer, the attended input sequence comprising a respective attended layer input at each of the one or more positions, and
the feed-forward layer configured to:
receive the attended input sequence; and
generate an output sequence for the layer from the attended input sequence, the output sequence comprising a respective layer output at each of the one or more positions,
wherein, for a first subset of the plurality of layers, the feed-forward sub-layer is a conditional computation sub-layer that (i) comprises a plurality of expert feed-forward neural networks and (ii) is configured to generate the output sequence for the layer by performing operations comprising, for each of the positions in the input sequence for the layer:
receiving the respective attended layer input at the position;
applying a gating function to the respective attended layer input at the position to generate a respective gate score for each of the plurality of expert feed-forward neural networks;
selecting, from the plurality of expert feed-forward neural networks, one or more expert feed-forward neural networks based at least on the respective gate scores;
processing the respective attended layer input at the position using each expert feed-forward neural in a proper subset of the plurality of expert feed-forward neural networks to generate a respective expert output for the expert feed-forward neural network in the proper subset, wherein the proper subset of the plurality of expert feed-forward neural networks comprises the one or more expert feed-forward neural networks that have been selected based at least on the respective gate scores;
combining the respective expert outputs to generate a combined expert output; and
generating the respective layer output at the position from the combined expert output.

14. The method of claim 13, wherein selecting the one or more expert feed-forward neural networks based at least on the respective gate scores comprises:
selecting k expert feed-forward neural networks with k highest respective gate scores among the plurality of expert feed-forward neural networks.

15. The method of claim 14, wherein k=1.

16. The method of claim 14, wherein k=2.

17. The method of claim 13, wherein, for a second subset of the plurality of layers, the feed-forward sub-layer is not a conditional computation sub-layer and is configured to generate the output sequence for the layer by processing the respective attended layer input at each of the one or more positions in the attended input sequence using a same feed forward neural network.

18. The method of claim 13, wherein the plurality of expert feed-forward neural networks have a same architecture but different parameter values.

19. The method of claim 13, wherein the attention mechanism comprises a multi-head self-attention mechanism.

20. The method of claim 13, wherein the machine learning task comprises one of:
a text generation task where the network output comprises a sequence of text; or
an image generation task where the network output comprises a sequence of intensity values for pixels of an image.
